(19) United States
(12) Patent Application Publication
(10) Pub. No.: US 2025/0326192 A1
(43) Pub. Date: Oct. 23, 2025

(54) METHOD FOR MANUFACTURING CONTINUOUS FIBER COMPOSITE FRAME

(71) Applicant: Euro-Ace Composite Manufacturing Co., Ltd., Taichung City (TW)

(72) Inventor: CHING-SONG SHAW, Taichung City (TW)

(21) Appl. No.: 19/226,681

(22) Filed: Jun. 3, 2025

Related U.S. Application Data
(63) Continuation-in-part of application No. 18/337,735, filed on Jun. 20, 2023.

(30) Foreign Application Priority Data
Feb. 14, 2023 (TW) 112105098

(51) Int. Cl. B29C 70/54; B29C 70/22; B29C 70/42; B29L 12/00

(52) U.S. Cl. CPC B29C 70/543; B29C 70/222; B29C 70/42; B29L 2012/005

(57) ABSTRACT

A method for manufacturing continuous fiber composite frame having steps of heating at least a portion of a continuous fiber bundle, bending the portion in three-dimensional directions along a fiber axis of the continuous fiber bundle in space, and creating multiple structural units; and bonding multiple connection points of the structural units to create a structural prototype.

### FIELD OF INVENTION

The present invention relates to a method for producing a frame, particularly a continuous fiber composite structure.

### BACKGROUND OF THE INVENTION

Fiber composite materials are widely used in various fields such as sports equipment, construction, wind terbines, transportation, ships, and aerospace, due to their high toughness, high material strength, favorable characteristics, and lightweight. However, the existing fiber composite are often made by plate-like or sheet-like, or cut the desired structure of a whole fiber composite to form a desired structure. These methods result in inferior mechanical properties such as reduced strength and modulus in the final products. Moreover, the process of cutting required sections from the whole fiber composite generates waste material, leading to lower material utilization rates, resource waste, environmental pollution, and increased costs of waste disposal.

In addition, some conventional methods of manufacturing fiber composite are produced by hot pressing. By putting pieces of prepreg fiber cloths or prepreg fiber bundles into the hot pressing mold as constituent units of the part, and then heating them to a temperature exceeding the melting point and pressure of the prepreg fiber cloths or prepreg fiber bundles to form the join. However, such process of manufacturing fiber composite requires heating the entire mold to high temperatures and the process consumes a lot of energy. Additionally, the constituent units may displace and deviate from their intended positions within the mold. Moreover, the constituent units may not attach properly to the mold, resulting in poor molding quality, loss of intricate structures, and reduced part strength.

### SUMMARY OF THE INVENTION

To solve abovementioned problems, this present invention discloses a method for manufacturing continuous fiber composite frame comprising steps of: heating at least a portion of a continuous fiber bundle, bending the portion in three-dimensional directions along a fiber axis of the continuous fiber bundle in space to form multiple structural units, wherein the continuous fiber bundle includes multiple fiber bundles coated with thermoplastic resin; and bonding multiple connection point of the structural units to create a structural prototype.

Wherein, the method further comprises a step of placing the structural prototype into a mold and shaping the structural prototype into a continuous fiber composite frame with compression molding.

Wherein, the connection points are bonded by ultrasonic welding at least two of the connection points.

Wherein, the connection points are bonded by heating and fusing at least two of the connection points.

Wherein, the connection points are bonded by gluing at least two of the connection points.

Wherein, the temperature during the compression molding does not exceed the melting point of the thermoplastic resin.

Wherein, the fiber bundles comprise carbon fiber, glass fiber, aramid fiber, or ceramic fiber.

Wherein, the thermoplastic resin comprises polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC).

Wherein, some or all of the structural units are closed circular structure, with two ends of the structural unit connected together.

Wherein, the method further comprises a step of coating the continuous fiber composites frame with a covering material.

Wherein, the covering material comprises elastic materials, foam materials, porous materials, or resin materials.

Wherein, the covering material comprises thermoplastic polyurethane, ethylene/vinyl acetate copolymer, rubber, or polyolefin.

Wherein, the bending process comprises passing the continuous fiber bundle through a shaper mold after heating, wherein the shaper mold comprises a tubular cavity with a three-dimensional bent cavity.

Wherein, the bending process comprises conveying the continuous fiber bundle to a bending machine, wherein the bending machine bends at least a portion of the continuous fiber bundle.

### BRIEF DESCRIPTION OF THE DRAWINGS

FIG. 1 is a schematic diagram of steps of a method in accordance with this invention.

FIG. 2 is a schematic view of the continuous fiber composite frame with this invention.

FIG. 3 is a schematic view of the structural units of the continuous fiber composite frame with this invention.

FIG. 3A is a partially enlarged view of a first structural unit of the continuous fiber composite frame in FIG. 3.

FIG. 3B is a partially enlarged view of a second structural unit of the continuous fiber composite frame in FIG. 3.

FIG. 4 is a combination schematic view of the structural units of the continuous fiber composite frame in FIG. 3 after combined.

FIG. 4A is a partially enlarged view of the combined structural units of the continuous fiber composite frame in FIG. 4.

### DETAILED DESCRIPTION OF THE PREFERRED EMBODIMENTS

Unless otherwise explicitly indicated in the context, terms such as “one,” “a,” “an,” or “the” in this specification and claims are not limited to singular form and may include plural forms. Generally, the terms “comprising” and “including” are used to indicate the presence of explicitly identified steps and elements, but these steps and elements do not preclude the presence of additional steps or elements.

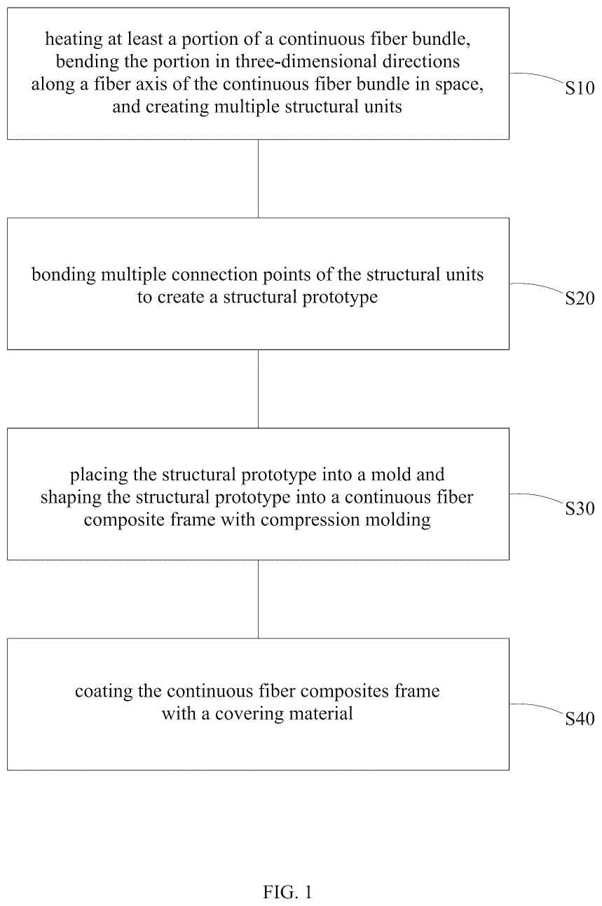

With reference to FIG. 1, a preferred embodiment of the method for manufacturing continuous fiber composite frame in accordance with this invention includes the following steps.

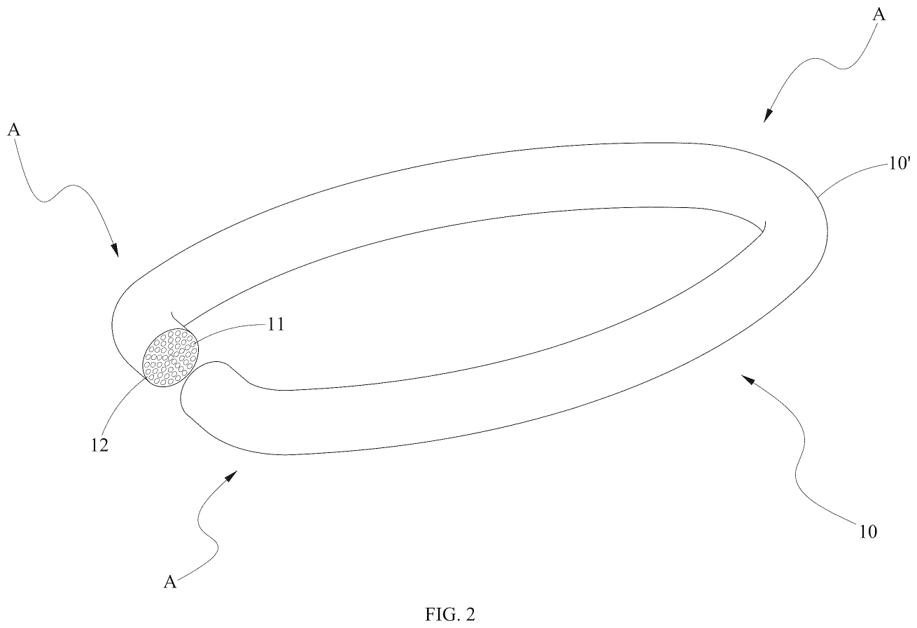

Step S10: Referring to the FIG. 2, heating at least a portion of a continuous fiber bundle 10 to from a bending region A, bending the bending region A in three-dimensional directions along a fiber axis of the continuous fiber bundle in space to form multiple structural units 10′. The continuous fiber bundle 10 includes multiple fiber bundles 11 coated with thermoplastic resin 12.

In step S10, the bending region A of the continuous fiber bundle 10 is subjected to at least partial heating, and the continuous fiber bundle 10 is bent in three-dimensional directions along the fiber axis in space. By partially heating the already cured and formed continuous fiber bundle 10, the thermoplastic resin 12 that encapsulates the continuous fiber bundle 10 softens at the bending region A. At this point, the bending region A becomes flexible and can be bent in three-dimensional space without breaking. Optionally, the heated region is then cooled, resulting in the multiple structural units 10′ with fixed shapes and structures. The terms “coating” and “encapsulation” refers to various methods, including but not limited to impregnation and co-extrusion, to ensure complete adhesion of the thermoplastic resin 12 to the fiber bundles 11. In one embodiment, the continuous fiber bundle 10 is impregnated with the thermoplastic resin 12 to form a composite material. The thermoplastic resin 12 adheres to and encapsulates the continuous fiber bundle 10, and the thermoplastic resin 12 is then cooled and solidified. The term “a portion of” referes to a part of the continuous fiber bundle 10 that are designated to be bent.

The fiber material of the continuous fiber bundle 10 may include carbon fiber, glass fiber, aramid fiber, ceramic fiber, or a combination thereof. The thermoplastic resin 12 may include one or a combination of polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC), among other polymer materials or combinations thereof. The term “continuous fiber bundle” refers to a collection of multiple fiber yarns assembled into a bundle, where the fiber yarns maintain continuity in the length direction for at least 2 centimeters, preferably exceeding 10 centimeters. Ideally, the length of the continuous fiber bundle 10 exceeds 1 meter. Most of the fibers in the continuous fiber bundle 10 have a length equal to the length of the long axis of the continuous fiber bundle 10. The materials used for the fiber bundle can include carbon fiber, glass fiber, aramid fiber, or ceramic fiber.

The term “bending in three-dimensional space” refers to the ability of the continuous fiber bundle 10 to bend in any direction along its longitudinal axis, without being limited to a requirement that any two bends must lie in a common plane. In other words, the continuous fiber bundle 10 can bend in multiple directions freely in three-dimensional space without the constraint of being confined to a single plane. The bending of the continuous fiber bundle 10 can be achieved through various methods. The continuous fiber bundle 10 can be manually bent using hand tools such as pliers, hammers, or nails to achieve the desired shape. Preferably, mechanical bending can be employed by using machinery such as rolling machines, bending machines, or shearing machines to bend the continuous fiber bundle 10 into the desired shape. Another approach is to guide and convey the continuous fiber bundle 10 into a shaper mold, where the continuous fiber bundle 10 can be bent according to the shape of the shaper mold. In a preferred embodiment, the continuous fiber bundle 10 is conveyed to a bending machine and subjected to a heating source to soften at least a part of the continuous fiber bundle 10. The heating source provides heating at a temperature that is higher than the glass transition temperature of the thermoplastic resin 12 but lower than the thermal decomposition temperature of the thermoplastic resin 12. The continuous fiber bundle 10 is bent at the locally heated and softened portion using the bending machine. The bending is not limited to bending in the same plane. By rotating the bending machine or rotating the continuous fiber bundle 10 itself, the continuous fiber bundle 10 can be bent in three-dimensional space. Preferably, by continuously feeding the continuous fiber bundle 10 through the bending machine and performing rotation and bending at specified parts of the continuous fiber bundle 10, the continuous fiber bundle 10 can be sequentially bent in a three-dimensional space from one end to the other end.

In another preferred embodiment, the continuous fiber bundle 10 is passed through the shaper mold after the bending region A being locally heated. The shaper mold has a three-dimensional curved tubular mold cavity. At least one of the bending region A of the continuous fiber bundle 10 is heated to a temperature above the glass transition temperature of the thermoplastic resin 12 and then guided through the three-dimensional curved tubular mold cavity to a specified position. Afterward, the continuous fiber bundle 10 is cooled and cured before being removed from the shaper mold. In a preferred manner, the continuous fiber bundle 10 is bent within the tubular mold cavity using a rotating wheel that drives the continuous fiber bundle 10 through the tubular mold cavity, causing the continuous fiber bundle 10 to bend. In another preferred embodiment, one end of the continuous fiber bundle 10 is attached to a guide structure. The continuous fiber bundle 10 is guided through the tubular mold cavity by moving and pulling the guiding structure along the tubular mold cavity, thereby inducing the desired bending in the continuous fiber bundle 10.

Furthermore, the structural units 10′formed by the heating and bending of the continuous fiber bundle 10 can have identical or different structures and shapes.

In particular, some or all of the structural units 10′ can form closed ring structures by connecting two radial ends of the continuous fiber bundle 10. These ring structures can have variable shapes and may have different winding numbers. The term “winding number” refers to the number of times the fiber bundle wraps around itself within the ring structure. This flexibility in ring structure formation enhances the adaptability and versatility of the structural units 10′. Furthermore, the fiber bundle materials and the thermoplastic resin 12 composition that encapsulates the fiber bundle materials in each of the continuous fiber bundle 10 can be the same or different for different continuous fiber bundles 10. This allows for the creation of structural units 10′ with different fiber bundle materials and thermoplastic resin 12 compositions, resulting in structural units 10′ with varied material properties. By tailoring the combination of fiber bundle materials and thermoplastic resins 12, specific characteristics such as strength, flexibility, heat resistance, or other desired properties can be achieved in each structural unit.

In an embodiment, some of the structural units 10′ exhibit multiple crossover points, and within or between these structural units 10′, there may be helical or braided winding patterns. The crossover points refer to the locations where the fiber bundles 11 cross over each other within the structural unit, creating intersections. The helical or braided winding patterns involve the twisting and intertwining of the fiber bundles 11, resulting in a spiral or braided configuration. These intricate winding patterns contribute to the overall structural complexity and enhance the mechanical properties and functionality of the composite material.

Alternatively, they can have partially similar or entirely different shapes and structures. This flexibility allows for customization and adaptation to specific design requirements and performance criteria. Depending on the desired outcome, the structural units can exhibit uniformity or variation, enabling the composite material to possess diverse properties and functionalities in different regions or sections. In one embodiment, a portion of the structural units is in the form of closed loop structures, while another portion exhibits different three-dimensional configurations. This combination of closed loop structures and other geometric shapes provides versatility and enhances the overall structural integrity and performance of the composite material. The closed loop structures contribute to load distribution and stability, while the other three-dimensional configurations may serve specific functional or aesthetic purposes. The integration of these different structural elements enables the composite material to meet various design requirements and optimize its performance in different applications.

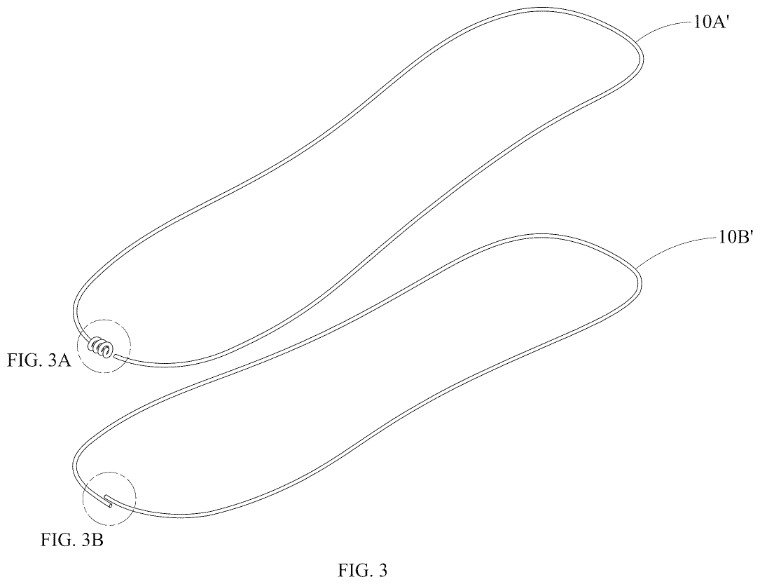

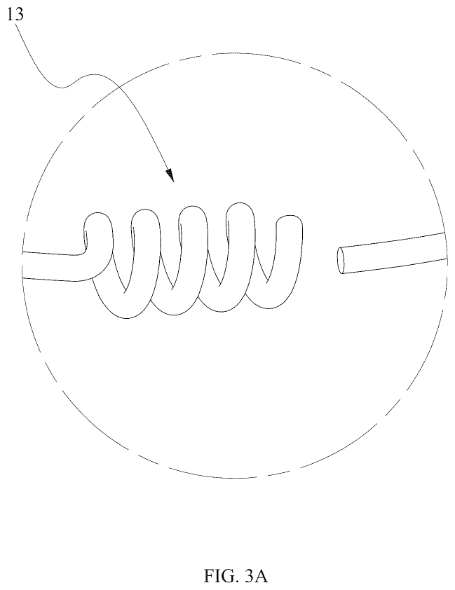

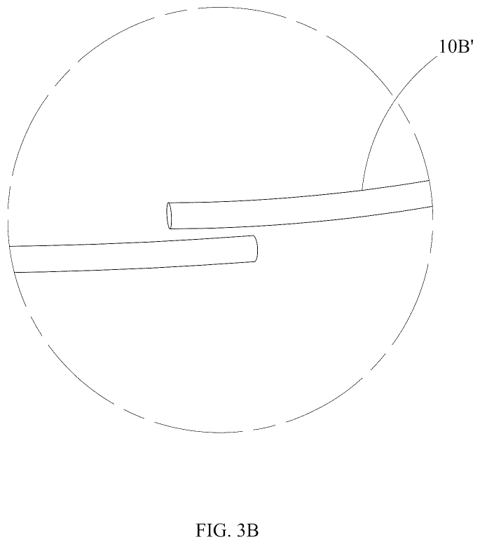

As shown in FIGS. 3 to 3B, in applications involving multiple continuous fiber bundles 10, a first structural unit 10A′ and a second structural unit 10B′ are generated by at least two of the continuous fiber bundles 10 have been completely shaped in the ring structure. Wherein the bending region A at one end of the first structural unit 10A′ is bent to form the spiral structure 13, and the first structural unit 10A′ has a height difference on two opposite sides of the ring structure after bending. The two ends of the second structural unit 10B′ overlap each other after bending to form a closed ring structure.

Step S20: Bonding at least two connection points 14 of the structural units 10′ /between at least two the structural units 10′ to create a structural prototype 20. The term “bonding” refers to the fixation of the at least two corresponding connection points 14 by connecting them together. The term “connection point” 14 refers to a local position within the structural unit 10 or the bending region A of the structural unit 10.

The connection point 14 can be mutually fixed with another connection point 14. The bonding between at least two corresponding connection points 14 can occur between two or more connection points 14 within the same structural unit, or between different connection points 14 on two or more different structural units 10′. The term “bond” denotes the process of securely fastening two or more connection points 14 together. Furthermore, the mutual bonding of multiple connection points 14 also includes the arrangement where consecutive connection points 14 form a linear or even planar configuration of connection. In one embodiment, two ring-shaped structural units 10′ each have a series of consecutive connection points 14 forming a connecting line. The connecting lines on each structural unit are mutually bonding, resulting in at least a partial linear connection between the two structural units 10′.

The methods of bonding the connection points 14 in step S20 include, but are not limited to, welding, fusion bonding, soldering, compression bonding, adhesive bonding, and other similar techniques. In a first preferred embodiment, ultrasonic welding is used as a method to bond the connection points 14. A high-frequency wave signal is generated by a transducer of an ultrasonic welding machine, and an ultrasonic energy is transmitted to at least two corresponding and contacting connection points 14 with a welding head of the ultrasonic welding machine. The ultrasonic energy causes the contact surfaces to melt and fuse together, resulting in the connection points 14 being connected. The welding head may apply moderate pressure during the ultrasonic welding to ensure a tight and secure bond between the connection points 14. In a second preferred embodiment, the method of bonding the connection points 14 in step S20 involves locally heating and contacting the at least two connection points 14 above the melting temperature of the thermoplastic resin 12 covering the connection points 14. The contact between the connection points 14 is maintained until the locally heated area cools down and the thermoplastic resin 12 is cured and solidified, thereby bonding the connection points 14 together as intended. In a third preferred embodiment, step S20 involves gluing at least a portion of the connection points 14 using a thermoplastic resin material. The thermoplastic resin material used for gluing can have the same or different composition as the thermoplastic resin 12 that covers the continuous fiber bundle 10 of each structural unit. In a fourth preferred embodiment, step S20 involves applying a solvent that dissolves the thermoplastic resin 12 of the structural units 10′ onto at least a portion of the connection points 14. The corresponding connection points 14 are then brought into contact. After the solvent has evaporated, the corresponding connection points 14 are brought into contact, resulting in the mutual bonding of the connection points 14.

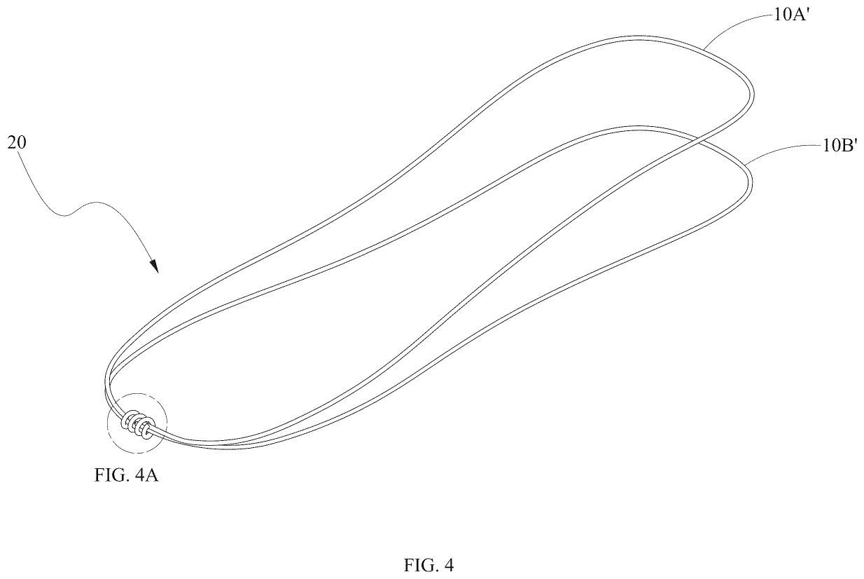

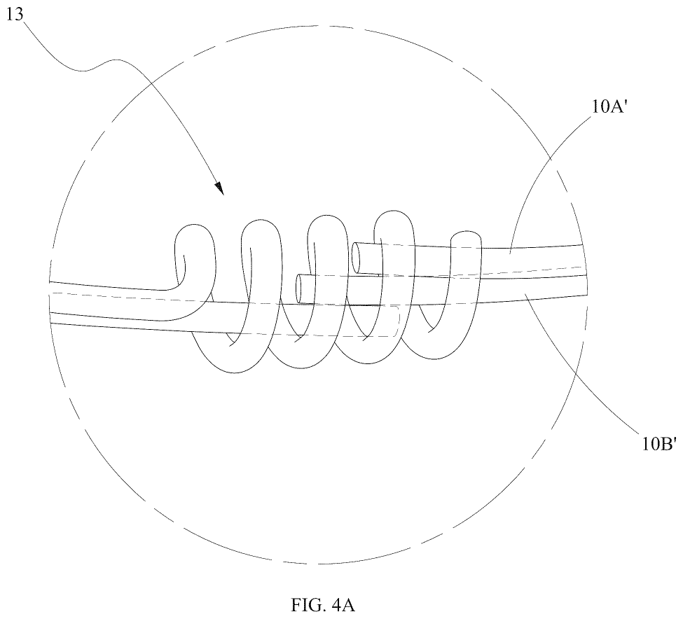

In a preferred embodiment, two ends of the continuous fiber bundle 10 are two of the connection points 14 and are bonded together, eliminating any noticeable endpoints of the continuous fiber bundle 10. As shown in FIG. 4 and FIG. 4A, in this embodiment, both the first structural unit 10A′ and the second structure unit 10B′ use the bending portion A as the connection point 14 as the connection point 14 to connect with each other. Wherein the end of the first structural unit 10A′ relative to the spiral structure 13 and both ends of the second structural unit 10B′ are inserted into the spiral structure 13, and then the first structural unit 10A′ and the second structural unit 10B′ can be bound by one of the above-mentioned methods. It is worthily noting that when applying the connection point 14 as the bending portion A, bonding the at least two connection points 14 in the step S20 can be performed directly after step S10, thus saving the intermediate curing process and avoiding unnecessary deformation of the continuous fiber bundle 10 due to repeated heating.

Worth noting is that the combination of the two connection points 14 creates an openwork structure there between, thereby constructing a lightweight frame with structural elasticity.

The structural prototype 20 is formed after the multiple connection points 14 of the structural units 10′ are bonded and cured. The structural prototype 20 can be used as a continuous fiber composite frame without further processing, or the structural prototype 20 can be further modified or processed through subsequent steps. In one embodiment, the connection points 14 of the multiple structural units 10′ are bonded together to form a structural prototype 20. The structural prototype 20 can be selectively trimmed or perforated in specific areas to create more intricate configurations while maintaining the overall structural integrity and enhancing efficiency of manufacturing.

Furthermore, the cross-sectional size and shape of each continuous fiber bundle 10 can be completely identical, partially identical, or entirely different. This allows for flexibility in designing and tailoring the geometry of each fiber bundle to suit specific application requirements. In one embodiment, the second structural unit 10B′ includes a larger cross-sectional then the first structural unit 10A′ that the first structural unit 10A′ can be more easily bent into the spiral structure 13 to be wrapped around the periphery of the second structural unit 10B′.

In addition, the difference in the material selection of each structural unit 10″ can also produce different physical properties. In this embodiment, the second structural unit 10B′ is made of a thermoplastic carbon fiber composite material with stronger hardness, while the first structural unit 10A′ is made of a thermoplastic glass fiber composite material. In this configuration allows the second structural unit 10B′ can be regarded as an axial core to exhibit material strength, while the spiral structure 13 of the first structural unit 10A′ can provide radial elastic characteristics at the connection of the second structural unit 10B′ and the first structural unit 10A′.

Step S30: Placing the structural prototype 20 into a mold and shaping the structural prototype 20 into a continuous fiber composite frame with compression molding. In step S30, the structural prototype 20 formed in step S20 is placed into one of the cavities of the mold. The mold is then closed, and pressure and heat are applied to the mold. The structural prototype 20 is soften and undergo bending and deformation. The structural prototype 20 thus conforms to the shape of the mold and forms the continuous fiber composite frame with curved surfaces and surface textures. This can be achieved by incorporating features in the design of the mold, such as contours, textures, or embossing, which will be transferred onto the surface of the thermoplastic resin 12 as it softens and conforms to the mold. By carefully designing the mold cavity, desired curves, shapes, and surface patterns can be imparted onto the structural prototype 20, resulting in desired curved surfaces and various surface textures. The mold is subsequently cooled, causing the thermoplastic resin 12 to cure. The cooling and curing of the thermoplastic resin 12 in the mold then preserves these features, allowing for the production of a continuous fiber composite frame with desired surface characteristics. The continuous fiber composite frame can then be removed from the mold.

In one embodiment, the mold is applied only to specific regions of the structural prototype 20, thereby altering a part of curvatures and surface textures of the structural prototype 20 and enhancing the strength of the connection points 14 at the same time. In another embodiment, the entire structural prototype 20 is fully enclosed within the mold for shaping.

Preferably, the temperature of the mold does not exceed the melting point of the thermoplastic resin 12. Heating below the melting point prevents undesired melting of the thermoplastic resin 12 and subsequent displacement of the continuous fiber bundles 10 within the mold. Therefore, intricate structures of the continuous fiber composite frame are preserved, and the continuous fiber composite frame does not require any further secondary processing. This control of the temperature ensures that the desired shape and structural features are maintained during the compression molding. Moreover, the heat source inputted into the mold exceeds the glass transition temperature (Tg) of the thermoplastic resin 12. Preferably, the heating temperature should exceed the heat distortion temperature (HDT) of the thermoplastic resin 12 but should not exceed the temperature of the melting point of the thermoplastic resin 12. Preferably, in embodiments where the structural prototypes 20 are composed of two or more thermoplastic resins 12 with different melting points, the heating temperature to the mold should not exceed the melting point of the thermoplastic resin 12 with the highest melting point. Since the connection points 14 of the structural prototype 20 are all bonded before step S30, the heat input required for the mold used in the compression molding process can be significantly reduced compared to traditional high-temperature molding. Additionally, the positioning of the mold can be more flexible. The mold can be selectively applied only to the surface of the structural prototype 20 to modify the surface of the structural prototype 20 or to enhance the bonding strength of the connection points 14.

Step S40: Coating the continuous fiber composites frame with a covering material. In this step S40, the method for manufacturing the continuous fiber composite frame further includes enveloping the continuous fiber composites frame with the covering material. Step S40 is an optional step in the method in accordance with this present invention. The covering material serves to enhance and protect the continuous fiber composite frame. Therefore, use of the covering material expands the range of applications for the continuous fiber composite frame, making it versatile and widely applicable. The continuous fiber composite frame creates a rigid structure along the axis of the continuous fiber bundle 10, providing strong rigidity, while the covering material offers a buffer against radial forces applied to the continuous fiber composite frame, preventing the fracture of the continuous fiber composite frame. Preferably, the covering material contains at least one species selected from the group consisting of elastic materials, foam materials, porous materials, or resin materials. Among them, the resin material can be either a thermosetting resin or a thermoplastic resin 12. If the resin material is a thermoplastic resin, the resin material can have the same or different composition as the thermoplastic resin of the continuous fiber composite frame. Furthermore, the resin material may contain fibers, wherein the fibers can be either continuous fibers or short fibers. The incorporation of fibers into the resin material can enhance strength, rigidity, and wear resistance of the resin material.

In some embodiments, the continuous fiber composite frame is placed in a second mold. Using injection molding or insert molding techniques, the covering material is injected into the second mold to form a protective layer or foam covering around the continuous fiber composite frame. Or the covering material is injected in the mold and foaming in step S30 that the continuous fiber composite material can apply the framework prototype 20 as a supporting structure and forming the foam body to having the soft shock absorption properties in step S30.

Furthermore, the covering material can be composed of thermoplastic polyurethane, ethylene/vinyl acetate copolymer, rubber, or polyolefin, among other components. This allows the method in accordance with present invention to generate the continuous fiber composite frames for shoe soles. Once the continuous fiber composite frame is completed, it can be further coated with the covering material.

The method in accordance with present invention can be applied to various applications including, but not limited to frameworks of electronic devices such as mobile phones, screens, laptops, AR/VR hardware. The continuous fiber composite frame can also be used for eyeglass frames, golf club heads, specialized shoe soles, and structural components of various sports products. The versatility of the method allows for the creation of durable and lightweight structures in a wide range of industries and products.

Based on the aforementioned description, the present invention has the following advantages:

1. The method for manufacturing the continuous fiber composite frame in accordance with the present invention involves pre-joining the connection points 14 of the structural units 10′ before compression molding. This reduces the heating temperature required for compression molding, resulting in significant energy savings.

2. The method for manufacturing the continuous fiber composite frame in accordance with the present invention involves pre-joining the connection points 14 of the structural units 10′ before compression molding. The reduction of the heating temperature required for compression molding avoids heating up a temperature above the melting point of the thermoplastic resin 12 which would cause the displacement of continuous fibers and the damage to the pre-preg fiber bundle structure and surface structure, thereby preserving the reduction of the strength of the continuous fiber composite frame. Additionally, this method reduces the time and cost associated with secondary processing.

3. The method for manufacturing the continuous fiber composite frame in accordance with the present invention involves pre-joining the connection points 14 of the structural units 10′ before compression molding. The reduction of heating temperature required for compression molding significantly reduces the time required for heating and cooling, and greatly increases production efficiency. Moreover, the reduced heating temperature helps minimize deformation of the mold and result in a smoother surface and improves accuracy of the continuous fiber composite frame. This enables the production of complex continuous fiber composite frames with intricate structures. Additionally, this method significantly increases the lifespan of the mold.

4. The method for manufacturing the continuous fiber composite frame in accordance with the present invention involves pre-joining the connection points 14 of the structural units 10′ before compression molding, thereby reducing the heating temperature required for compression molding. This allows for a more diverse and flexible selection of mold materials, eliminating the need for expensive molds with high melting points and low thermal deformation requirements in traditional high-temperature molding processes. As a result, the method in accordance with this invention helps reduce the overall cost of molds and improve the process.

5. The method for manufacturing the continuous fiber composite frame in accordance with the present invention involves pre-joining the connection points 14 of the structural units 10′ before compression molding. This preforming process allows for more precise control over the fine structure of the frame and ensures the quality of the formation of the continuous fiber composite frame. As a result, the method in accordance with this invention achieves configurations and levels of precision that cannot be attained by traditional methods of assembling individual components using compression molding.

6. The method for manufacturing the continuous fiber composite frame in accordance with the present invention involves pre-joining the connection points 14 of the structural units 10′ before compression molding. The reduction of the heating temperature required for the compression molding process leads no need to heat the structural units 10′ above the melting point of the thermoplastic resin 12. This prevents excessive softening of the structural units 10′ and uncontrollable flow of the thermoplastic resin 12 during the compression molding process of the structural prototype 20. Furthermore, by eliminating the need to fully enclose the structural prototype 20 in the mold during the compression molding process, the mold can be placed more flexibly and with greater versatility. Localized compression molding can be applied to specific areas of the structural prototype 20 without affecting other parts of the structural prototype 20. This leads to cost savings in mold production and eliminates size limitations imposed by the dimensions of the mold. As a result, the method in accordance with this invention makes it possible to produce large-scale and complex continuous fiber composite frames.

7. The method for manufacturing the continuous fiber composite frames in accordance with this invention uses continuous fiber bundles 10, which helps in conserving production materials, increasing material utilization rates, and reducing waste. As a result, the method in accordance with this invention lowers manufacturing costs and minimizes waste disposal.

8. The method in accordance with present invention utilizes thermoplastic resin 12 as the base material for the continuous fiber composite frames, making the continuous fiber composite frames recyclable and reusable at the end of its lifecycle. The method in accordance with this invention achieves the benefits of promoting green and environmentally friendly practices. This approach helps reduce waste, conserve resources, and minimize the environmental impact associated with the production and disposal of the continuous fiber composite frames.

9. The continuous fiber composite frame manufactured by the method in accordance with this invention can form a three-dimensional framework in space, offering a high degree of design freedom. The method in accordance with this invention allows for the fabrication of complex components and enables highly customized and integral formation of the continuous fiber composite frame, and the method greatly increase structural integrity of the continuous fiber composite frame. This approach significantly enhances the mechanical performance of the continuous fiber composite frame, providing high structural strength and a high elastic modulus for various applications. Additionally, the method in accordance with this invention can further combines multiple continuous fiber composite frame or further coats the continuous fiber composite frame with the covering material, offering various configuration and a high level of flexibility.

What is claimed is:

1. A method for manufacturing continuous fiber composite frame the method comprising the ordered steps of:
heating at least a portion of a continuous fiber bundle to from at least a bending region, wherein the continuous fiber bundle includes multiple fiber bundles coated with a thermoplastic resin having a melting point;
bending the at least a bending region of the continuous fiber bundle in three-dimensional directions along a fiber axis of the continuous fiber bundle in space to form multiple structural units; and
bonding two connection points between one or two of the multiple structural units to create a structural prototype.

2. The method for manufacturing according to claim 1, wherein one of the connection points is the bending region.

3. The method for manufacturing according to claim 1, wherein the method further comprises:
placing the structural prototype into a mold; and
using compression molding to shape the structural prototype into the continuous fiber composite frame.

4. The method for manufacturing according to claim 1, wherein ultrasonic welding bonds the first connection point to the second connection point.

5. The method for manufacturing according to claim 1, wherein heating and fusing bonds the first connection point to the second connection point.

6. The method for manufacturing according to claim 1, wherein gluing bonds at least the first connection point to the second connection point.

7. The method for manufacturing according to claim 2, wherein a temperature during compression molding does not exceed the melting point of the thermoplastic resin.

8. The method for manufacturing according to claim 1, wherein the fiber bundles comprise carbon fiber, glass fiber, aramid fiber, or ceramic fiber.

9. The method for manufacturing according to claim 1, wherein the thermoplastic resin comprises polyoxymethylene (POM), acrylonitrile-butadiene-styrene (ABS), polyphenylene sulfide (PPS), polysulfone (PSU), polyether sulfone (PES), polyether ether ketone (PEEK), liquid crystal polymer (LCP), polyetherimide (PEI), polyamide-imide (PAI), polyformaldehyde (POM), nylon (PA), polycarbonate (PC), polybutylene terephthalate (PBT), polyethylene terephthalate (PET), polyphenyl ether (PPE), acrylonitrile-styrene-acrylate (ASA), polystyrene (PS), polymethyl methacrylate (PMMA), methyl styrene copolymer (MS), cellulose acetate (CA), thermoplastic polyurethane (TPU), thermoplastic polyester elastomer (TPEE), styrenic thermoplastic elastomer (TPS), elastomer (PAE), polytetrafluoroethylene (PTFE), vinylon, polypropylene (PP), polyethylene (PE), ethylene/vinyl acetate copolymer (EVA), or polyvinyl chloride (PVC).

10. The method for manufacturing according to claim 1, wherein each structural unit has a first end and a second end, and wherein at least some of the structural units have a closed circular structure and the first end of the structural unity and the second end of the structural unit are connected together.

11. The method for manufacturing according to claim 2, wherein each structural unit has a first end and a second end, and wherein at least some of the structural units have a closed circular structure and the first end of the structural unity and the second end of the structural unit connected together.

12. The method for manufacturing according to claim 2, wherein the method further comprises coating the continuous fiber frame with a covering material.

13. The method for manufacturing according to claim 11, wherein the covering material comprises elastic materials, foam materials, porous materials, or resin materials.

14. The method for manufacturing according to claim 11, wherein the covering material comprises thermoplastic polyurethane, ethylene/vinyl acetate copolymer, rubber, or polyolefin.

15. The method for manufacturing according to claim 1, wherein the step of bending the heated portion of the continuous fiber bundle comprises passing the heated portion of the continuous fiber bundle through a shaper mold, wherein the shaper mold comprises a tubular cavity with a three-dimensional bent cavity.

16. The method for manufacturing according to claim 2, wherein the step of bending the heated portion of the continuous fiber bundle comprises passing the heated portion of the continuous fiber bundle through a shaper mold, wherein the shaper mold comprises a tubular cavity with a three-dimensional bent cavity.

17. The method for manufacturing according to claim 1, wherein the step of bending the heated portion of the continuous fiber bundle comprises conveying the continuous fiber bundle to a bending machine, wherein the bending machine bends at least a portion of the heated portion of the continuous fiber bundle.

18. The method for manufacturing according to claim 2, wherein the step of bending the heated portion of the continuous fiber bundle comprises conveying the continuous fiber bundle to a bending machine, wherein the bending machine bends at least a portion of the heated portion of the continuous fiber bundle.
